(19) United States
(12) Patent Application Publication
(10) Pub. No.: US 2016/0257859 A1
(43) Pub. Date: Sep. 8, 2016

(54) Method for Retaining a Dry Tissue Dispenser On Horizontal Surface

(71) Applicant: Thomas Graffy, Oxnard, CA (US)

(72) Inventor: Thomas Graffy, Oxnard, CA (US)

(21) Appl. No.: 14/883,215

(22) Filed: Oct. 14, 2015

Related U.S. Application Data
(63) Continuation-in-part of application No. 14/637,044, filed on Mar. 3, 2015, now abandoned.

(51) Int. Cl. C09J 7/02; A47K 10/42; B65D 83/08

(52) U.S. Cl. CPC C09J 7/0246; B65D 83/0805; A47K 10/421; C09J 7/025; C09J 7/0289; A47K 2010/3233

(57) ABSTRACT

A method for retaining a dry tissue dispenser on a horizontal surface within reach of a patient. Extracting dry tissue from the dispenser often requires holding the dispenser with one hand and extracting the dry tissue with the other hand. Hospital, rehab facility, and assisted living facility patients often have the use of only one hand, making extracting the dry tissue very difficult and frustrating. The dispenser includes a Pressure Sensitive Adhesive (PSA) pad for temporary attaching to a horizontal surface. The dispenser with the PSA pad on the bottom may be attached to a night stand, table, or desk next to a bed or seating, etc., within the reach of the patient to easily extract tissue from the dispenser using only a single hand. The PSA is initially covered by a release layer torn away to expose a low strength adhesive.

### CROSS-REFERENCE TO RELATED APPLICATIONS

The present application is a Continuation In Part of U.S. patent application Ser. No. 14/637,044 filed Mar. 3, 2015, which application is incorporated in its entirety herein by reference.

### BACKGROUND OF THE INVENTION

The present invention relates to dry tissue dispensers and in particular to a dry tissue dispenser with an adhesive strip on the base of the tissue dispenser box for fixing the tissue dispenser to a surface.

Dry tissue dispensers are used all over the world to provide consumers with a convenient and compact source for facial tissue. The dry tissue dispensers are available in several sizes and shapes to suit consumer preferences.

In general, withdrawing dry tissues from the dry tissue dispensers requires pulling the dry tissue through a restricted opening (or slot) and often the dispenser must be held while the dry tissue is withdrawn. Often two or more dry tissues cling together, making withdrawing the dry tissue even more difficult. This difficulty in withdrawing dry tissue often requires a user to both hold the dispenser with one hand and withdraw the dry tissue with the other hand.

Such dry tissue dispensers may be used by temporarily or permanently disabled patients in hospitals, rehab facilities, and assisted living facilities. The patients often have difficulty with simple tasks, and may not have use of both hands. The dry tissue dispensers must be grasped with the available hand and be moved to a position where the patient can somehow grasp and withdraw the dry tissue from the dry tissue dispenser (which is often difficult), and then return the dry tissue dispenser to the original location. All of this requires time and adds to the discomfort and frustration the patient is already experiencing. No solution to these difficulties has been found.

### BRIEF SUMMARY OF THE INVENTION

The present invention addresses the above and other needs by providing a method for retaining a dry tissue dispenser on a horizontal surface within reach of a patient. Extracting dry tissue from the dispenser often requires holding the dispenser with one hand and extracting the dry tissue with the other hand. Hospital, rehab facility, and assisted living facility patients often have the use of only one hand, making extracting the dry tissue very difficult and frustrating. The dispenser includes a Pressure Sensitive Adhesive (PSA) pad for temporary attaching to a horizontal surface. The dispenser with the PSA pad on the bottom may be attached to a night stand, table, or desk next to a bed or seating, etc., within the reach of the patient to easily extract tissue from the dispenser using only a single hand. The PSA is initially covered by a release layer torn away to expose a low strength adhesive.

In accordance with one aspect of the invention, there is provided a method for positioning and retaining a dry tissue dispenser on a horizontal surface within reach of a hospital patient. The method includes the steps of positioning a dry tissue dispenser on a horizontal surface, determining if a patient can reach and extract dry tissue from the dry tissue dispenser, if the patient cannot reach and extract dry tissue from the dry tissue dispenser, repositioning the dry tissue dispenser on the horizontal surface, when the patient can reach and extract dry tissue from the dry tissue dispenser, saving the position of the dry tissue dispenser, removing a release layer residing on the dry tissue dispenser, and adhering the dry tissue dispenser to the horizontal surface in the saved position.

In accordance with another aspect of the invention, there is provided a dry tissue dispenser having a removable Pressure Sensitive Adhesive (PSA) strip for attaching to a night stand, table, or desktop surface. The PSA may be die cut from well known double sided material and attached to the bottom of the dry tissue dispenser. Such material is available in various thicknesses and grip strength (from light to aggressive) from various suppliers, for example, 3M®.

In accordance with yet another aspect of the invention, there is provided a dry tissue dispenser including a rigid box. A removable Pressure Sensitive Adhesive (PSA) strip on the bottom of the rigid box is attached to a night stand, table, or desktop surface entirely by force transmitted through the rigid box without compressing dry tissue contained in the box. Compressing the dry tissue in the dry tissue dispenser would make extraction of the tissue more difficult for a patient having use of a single hand, compromising the purpose of the present invention.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1A is a top perspective view of a typical dry tissue dispenser according to the present invention.

FIG. 1B is a bottom perspective view of the dry tissue dispenser according to the present invention.

FIG. 2 is side view of the dry tissue dispenser according to the present invention.

FIG. 3 shows the dry tissue dispenser attached to furniture next to a bed, according to the present invention.

FIG. 4 is a method according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the term “generally” is associated with an element of the invention, it is intended to describe a feature's appearance to the human eye or human perception, and not a precise measurement.

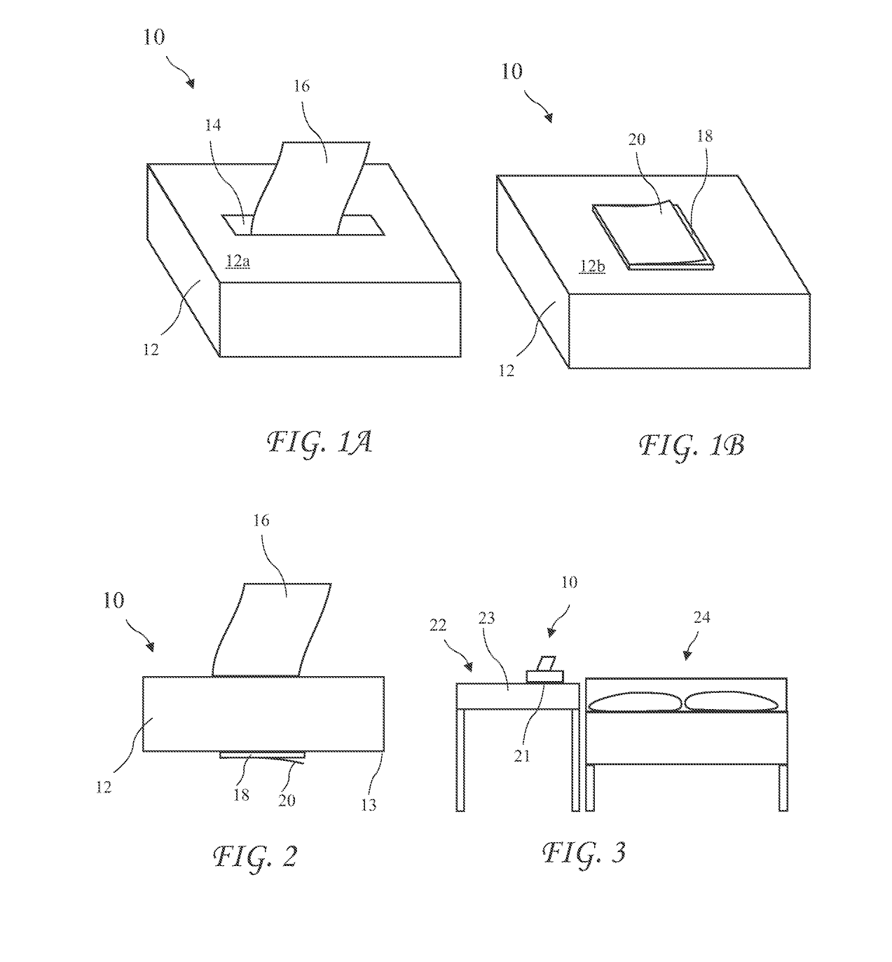

A top perspective view of a dry tissue dispenser 10 according to the present invention is shown in FIG. 1A, a bottom perspective view of the dry tissue dispenser 10 is shown in FIG. 1B, and a side view of the dry tissue dispenser 10 is shown in FIG. 2. The dry tissue dispenser 10 includes a box 12 holding dry tissue 16. The dry tissue 16 is released through a slot 14 in a top surface 12a of the box 12. A supporting substrate 20 of a Pressure Sensitive Adhesive (PSA) 18 is attached to the bottom 12b of the box 12, and a release layer 20 resides over the supporting substrate of the PSA 18 prior to attaching the dry tissue dispenser 10 to a surface for convenient single handed use. The PSA 18 may be attached to any location on the bottom 12b of the box 12, for example, attached along one or more edge of the bottom 12b or centered on the bottom 12b, and the PSA 18 is preferably generally centered on the bottom 12b. The dry tissue 16 is preferably facial dry tissue.

The tissue box 12 is preferably a generally rigid (i.e., retains shape under normal use) cardboard box retaining a generally rectangular shape. The box 12 is sufficiently rigid to transmit pressure on the top 12a of the box 12 to the bottom 12b of the box 12 for attaching the PSA 18 to the horizontal surface. The force is preferably transmitted by the box 12 only, and not transmitted by tissue 16 within the box 12, thus avoiding compacting the tissue 16 which would make withdrawing the tissue more difficult. After opening, the box 12 remains open allowing one handed access to the tissue 16 in the box 12.

The PSA may include a supporting substrate made from a foamed material, such as styrene, polyurethane, or the like. When the top layer is elastic and has a sufficient thickness, it can be bonded effectively to an uneven surface, and can be easily peeled off the surface. An example of a suitable PSA is an adhesive tape manufactured by 3M® and sold under the trademark VHB®.

The dry tissue dispenser 10 is shown attached to a generally horizontal surface 23 of furniture 22 next to a bed 24 in FIG. 3. The furniture 22 may be a night stand, table, desk, cart or any furniture positioned next to a bed or next to seating. Once the dry tissue dispenser 10 is thus attached, a user may easily withdraw dry tissue 16 using a single hand.

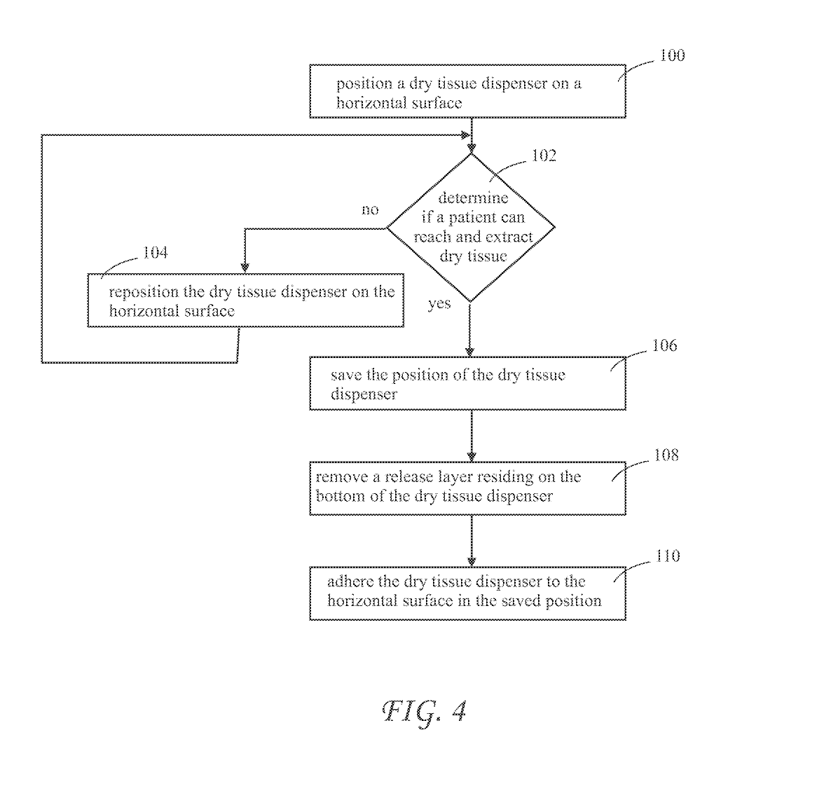

A method for retaining the dry tissue dispenser on a horizontal surface within the reach of a patient is described in FIG. 4. The method includes positioning a dry tissue dispenser on a horizontal surface at step 100, determining if a patient can reach and extract dry tissue from the dry tissue dispenser, with a single hand, at step 102, if the patient cannot reach and extract dry tissue from the dry tissue dispenser, repositioning the dry tissue dispenser on the horizontal surface at step 104, when the patient can reach and extract dry tissue from the dry tissue dispenser, saving the position of the dry tissue dispenser at step 106, removing a release layer residing on the dry tissue dispenser at step 108, and adhering the dry tissue dispenser to the horizontal surface in the saved position at step 110.

Saving the position of the dry tissue dispenser at step 106 may merely be making a mental reference of the saved position, or placing an object on or next to the saved position, or marking the saved position on the horizontal surface. The dry tissue dispenser may be opened before or after adhering the dry tissue dispenser to the horizontal surface, and once opened, remains open to allow easy one handed access to tissue in the dry tissue dispenser.

While the invention herein disclosed has been described by means of specific embodiments and applications thereof, numerous modifications and variations could be made thereto by those skilled in the art without departing from the scope of the invention set forth in the claims.

1. A method for positioning and retaining a dry tissue dispenser on a horizontal surface, the method comprising:
positioning a dry tissue dispenser on a horizontal surface;
determining if a patient can reach and extract dry tissue from the dry tissue dispenser;
if the patient cannot reach and extract the dry tissue from the dry tissue dispenser, repositioning the dry tissue dispenser on the horizontal surface; and
if the patient can reach and extract the dry tissue from the dry tissue dispenser, adhering the dry tissue dispenser to the horizontal surface.

2. The method of claim 1, further including:
if the patient can reach and extract dry tissue from the dry tissue dispenser after positioning or repositioning the dry tissue dispenser to a current position, perform the additional steps of:
saving the current position of the tissue dispenser as a saved position;
removing a release layer residing on the dry tissue dispenser; and
adhering the dry tissue dispenser to the horizontal surface in the saved position.

3. The method of claim 2, wherein saving the current position of the tissue dispenser comprises remembering the current position.

4. (canceled)

5. The method of claim 2, wherein saving the current position of the tissue dispenser comprises marking the current position on the horizontal surface.

6. The method of claim 1, further including permanently opening the dry tissue dispenser before adhering the dry tissue dispenser to the horizontal surface.

7. The method of claim 1, further including permanently opening the dry tissue dispenser after adhering the dry tissue dispenser to the horizontal surface.

6. The method of claim 1, wherein the dry tissue dispenser comprises:
a rigid box containing the dry tissue;
a permanently openable slot on a top surface of the box for extracting the dry tissue; and
a Pressure Sensitive Adhesive (PSA) attached to a bottom surface of the box.

7. The method of claim 6, wherein the PSA comprises:
a supporting substrate attached to the bottom surface of the box; and
a removable release layer residing on a supporting substrate opposite to the box.

8. The method of claim 7, wherein the supporting substrate is a foamed material.

9. The method of claim 8, wherein the foamed material is styrene.

10. The method of claim 8, wherein the foamed material is polyurethane.

11. The method of claim 6, wherein the PSA is generally centered on the bottom surface of the box.

12. The method of claim 6, wherein the PSA is attached along at least one edge of the bottom surface of the box.

13. The method of claim 1, wherein the dry tissue dispenser is a generally rigid box and adhering the dry tissue dispenser to the horizontal surface comprises pressing down on the rigid box to adhere a Pressure Sensitive Adhesive (PSA) on a bottom surface of the rigid box to the horizontal surface while avoiding compressing the dry tissue in the rigid box.

14. The method of claim 13, wherein pressing down on the rigid box to adhere the PSA on a bottom surface of the rigid box to the horizontal surface includes avoiding compressing the dry tissue in the rigid box.

15. A method for positioning and retaining a dry tissue dispenser on a horizontal surface, the method comprising:
positioning a dry tissue dispenser on a horizontal surface, the dry tissue dispenser comprising:
a rigid box containing dry tissue;
a permanently openable slot on a top surface of the box for extracting the dry tissue; and
a Pressure Sensitive Adhesive (PSA) attached to a bottom surface of the box.;
determining if a patient can reach and extract dry tissue from the dry tissue dispenser;
if the patient cannot reach and extract dry tissue from the dry tissue dispenser:
repositioning the dry tissue dispenser on the horizontal surface; and
again determining if a patient can reach and extract dry tissue from the dry tissue dispenser; and
if the patient can reach and extract dry tissue from the dry tissue dispenser:
noting the position of the dry tissue dispenser;
removing a release layer from a Pressure Sensitive Adhesive on a bottom of the rigid box;
positioning the dry tissue dispenser in the noted position; and
pressing down on the rigid box to adhere the PSA on a bottom surface of the rigid box to the horizontal surface while avoiding compressing the dry tissue in the rigid box.

16. The method of claim 15, further including permanently opening the rigid box to allow access to the dry tissue before the initial positioning of the dry tissue dispenser.

17. The method of claim 15, further including permanently opening the rigid box to allow access to the dry tissue after adhering the rigid box to the horizontal surface.

18. A method for positioning and retaining a dry tissue dispenser on a horizontal surface, the method comprising:
obtaining a dry tissue dispenser comprising:
a rigid box containing the dry tissue;
a permanently openable slot on a top surface of the rigid box for extracting the dry tissue; and
a Pressure Sensitive Adhesive (PSA) attached to a bottom surface of the box;
removing a release layer from a Pressure Sensitive Adhesive on a bottom of the rigid box;
positioning the dry tissue dispenser on a horizontal surface of furniture residing next to a bed or seating of a facility selected from a hospital, a rehab facility, and an assisted living facility;
pressing down on the rigid box to adhere the PSA on a bottom surface of the rigid box to the horizontal surface while avoiding compressing the dry tissue in the rigid box; and
a disabled patient residing on the bed or seating in the facility removing the dry tissue from the dry tissue dispenser using a single hand, allowing use of the dry tissue without holding the dry tissue dispenser with a second hand.

19-20. (canceled)

21. The method of claim 1, wherein the patient is a temporarily or permanently disabled patient and further including, the temporarily or permanently disabled patient removing the dry tissue from the dry tissue dispenser using a single hand without holding the dry tissue dispenser with a second hand.

22. The method of claim 21, wherein:
the temporarily or permanently disabled patient resides in a facility selected from a hospital, a rehab facility, and an assisted living facility; and
the horizontal surface is part of furniture positioned next to a bed or next to seating, in the facility used by the temporarily or permanently disabled patient.

23. The method of claim 1, wherein:
the patient is a temporarily or permanently disabled patient and further including, the temporarily or permanently disabled patient removing the dry tissue from the dry tissue dispenser using a single hand without holding the dry tissue dispenser with a second hand;
the temporarily or permanently disabled patient resides in a facility selected from a hospital, a rehab facility, and an assisted living facility; and
the horizontal surface is part of furniture positioned next to a bed or next to seating, in the facility used by the temporarily or permanently disabled patient.
